(19) United States
(12) Patent Application Publication
(10) Pub. No.: US 2026/0217205 A1
(43) Pub. Date: Jul. 30, 2026

(54) PROTECTOR UNIT AND WIRE HARNESS

(71) Applicant: Yazaki Corporation, Tokyo (JP)

(72) Inventors: Katsuya YOSHIMURA, Aichi (JP); Shinichi IKEDA, Shizuoka (JP); Yuka OGAWA, Shizuoka (JP); Tomoharu INAYOSHI, Toyota-shi (JP)

(73) Assignee: Yazaki Corporation, Tokyo (JP)

(21) Appl. No.: 19/446,289

(22) Filed: Jan. 12, 2026

(30) Foreign Application Priority Data
Jan. 27, 2025 (JP) 2025-011109

(51) Int. Cl. B60R 16/02; F16B 2/22

(52) U.S. Cl. CPC B60R 16/0215; F16B 2/22

(57) ABSTRACT

A protector unit includes a clip provided with an insertion space portion into which a plate-shaped rib on a vehicle side is inserted along an assembly direction, and a protector that movably supports the clip along the assembly direction between a temporary locking position and a final locking position. The clip moves from the temporary locking position toward the final locking position by going over a temporary locking portion along the assembly direction as a rib is inserted into the insertion space portion in a state of being held by the temporary locking portion of the protector, and is locked to the rib by being pressed by the temporary locking portion having returned to a free state from both sides in a width direction.

### CROSS-REFERENCE TO RELATED APPLICATION(S

The present application claims priority to and incorporates by reference the entire contents of Japanese Patent Application No. 2025-011109 filed in Japan on January 27, 2025.

### BACKGROUND OF THE INVENTION

### Field of the Invention

The present invention relates to a protector unit and a wire harness.

### Description of the Related Art

As a technique related to a conventional protector unit, for example, DE 102015102825 B3 discloses a protector unit including a clip inserted into a rib on a vehicle side and a protector body holding the clip.

In the conventional protector unit, for example, the protector body may be easily detached from the clip locked to the rib, and further improvements could be made to enhance the assemblability of the protector unit.

### SUMMARY OF THE INVENTION

The present invention has been made in view of the above circumstances, and an object of the present invention is to provide a protector unit and a wire harness capable of improving the assemblability.

In order to achieve the above mentioned object, a protector unit according to one aspect of the present invention includes a clip including an insertion space portion into which a plate-shaped rib on a vehicle side is inserted along an assembly direction; and a protector including a protector body that supports the clip so as to be movable between a temporary locking position and a final locking position along the assembly direction, a temporary locking portion that is provided in the protector body and holds the clip at the temporary locking position, and a final locking portion that is provided in the protector body and holds the clip at the final locking position, wherein the clip moves from the temporary locking position toward the final locking position by going over the temporary locking portion along the assembly direction as the rib is inserted into the insertion space portion in a state of being held by the temporary locking portion, and is locked to the rib by being pressed, by the temporary locking portion having returned to a free state, from both sides in a width direction intersecting the assembly direction.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an exemplary perspective view of a wire harness to which a protector unit according to an embodiment is applied;

FIG. 2 is an exemplary perspective view of the protector unit according to the embodiment;

FIG. 3 is an exemplary exploded perspective view of the protector unit according to the embodiment;

FIG. 4 is an exemplary plan view of a protector body of the protector unit according to the embodiment;

FIG. 5 is an exemplary perspective view of a clip of the protector unit according to the embodiment;

FIG. 6 is an exemplary perspective view of the protector unit according to the embodiment at a temporary locking position;

FIG. 7 is an exemplary cross-sectional view of the protector unit according to the embodiment at the temporary locking position;

FIG. 8 is an exemplary perspective view of the protector unit according to the embodiment at a final locking position; and

FIG. 9 is an exemplary cross-sectional view of the protector unit according to the embodiment at the final locking position.

### DETAILED DESCRIPTION OF THE PREFERRED EMBODIMENTS

Hereinafter, an embodiment according to the present invention will be described in detail with reference to the drawings. Note that the present invention is not limited to the following embodiment. In addition, constituent elements in the following embodiment include those that can be easily replaced by those skilled in the art or those that are substantially the same. In the present specification, ordinal numbers are used only to distinguish components, members, parts, positions, directions, and the like, and they do not indicate order or priority.

### Embodiment

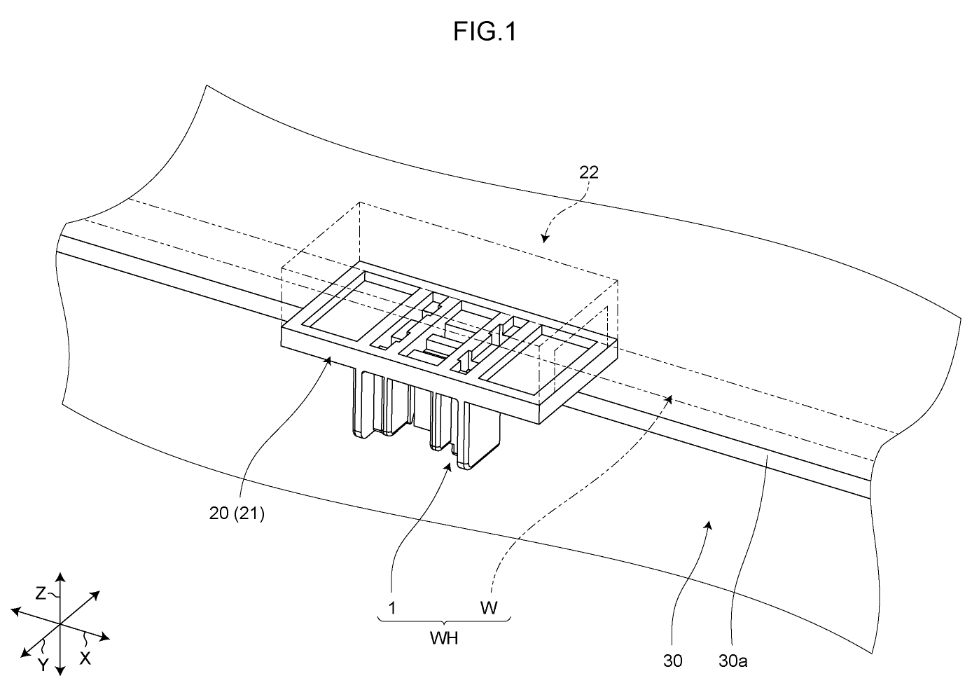

FIG. 1 is a perspective view of a wire harness WH to which a protector unit 1 according to an embodiment is applied. The protector unit 1 of the present embodiment illustrated in FIG. 1 is incorporated in the wire harness WH routed in a vehicle such as an automobile. The wire harness WH is configured, for example, such that wiring members W used for power supply and signal communication are bundled to form a collective component for connection between devices mounted in the vehicle and the wiring members W are connected to the devices by a connector or the like. The wire harness WH of the present embodiment includes, for example, the wiring member W having conductivity and the protector unit 1 externally mounted on the wiring member W. The wire harness WH may further include various components such as a grommet, an electrical connection box, and a fixture.

In the following description, among a first direction, a second direction, and a third direction intersecting, the first direction is referred to as an "axial direction X", the second direction is referred to as a "width direction Y", and the third direction is referred to as an "assembly direction Z". Here, the axial direction X, the width direction Y, and the assembly direction Z are substantially orthogonal to each other. The axial direction X is typically along the extending direction of the wiring member W, the insertion direction of the wiring members W into the protector unit 1, the longitudinal direction of the protector unit 1, and the like. The width direction Y is typically along the width direction of the protector unit 1 and the like. The assembly direction Z is typically along the height direction (vertical direction) of the protector unit 1, the assembly direction of the protector unit 1 with respect to a rib 30 on the vehicle side, and the like. Each direction used in the following description will be explained as a direction in a state where the protector unit 1 is assembled to the vehicle unless otherwise specified.

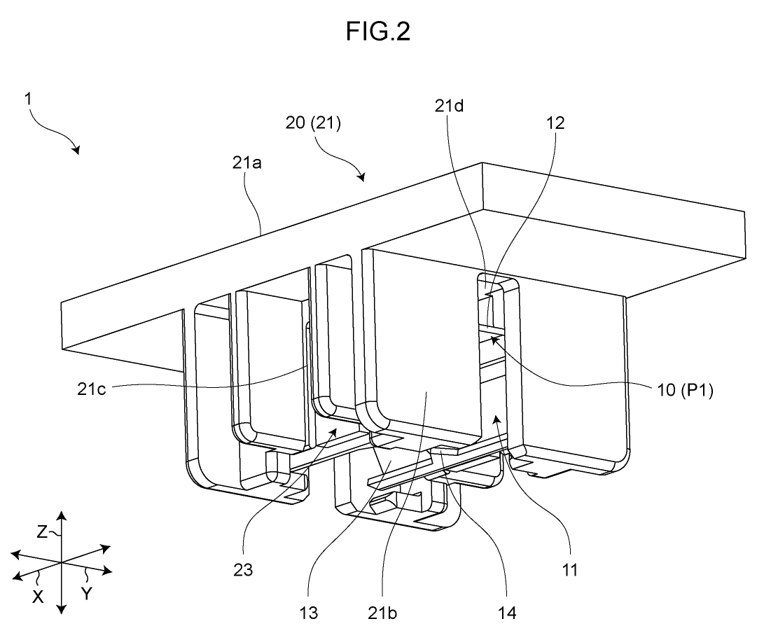

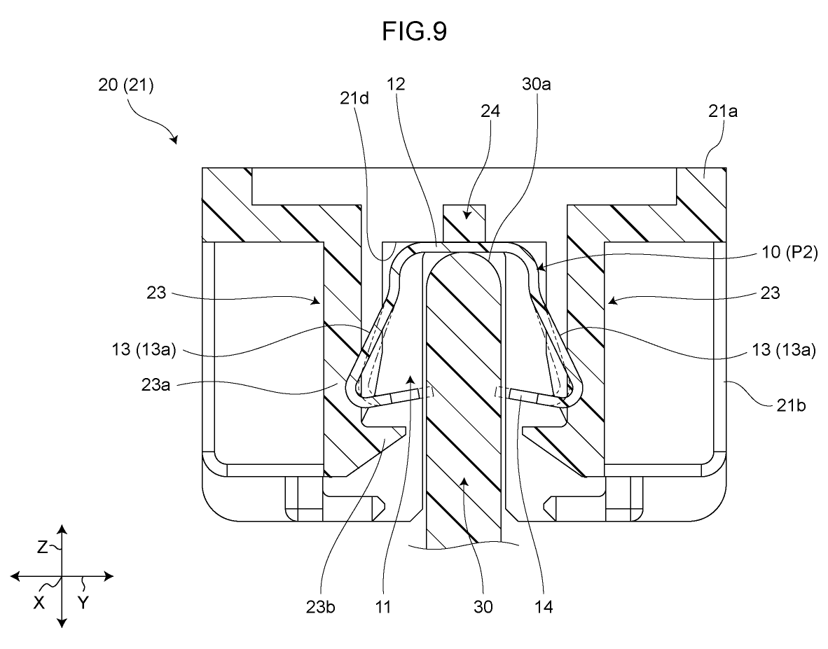

FIG. 2 is a perspective view of the protector unit 1. As illustrated in FIGS. 1 and 2, the protector unit 1 includes a clip 10 locked to the rib 30 on the vehicle side, and a protector 20 that supports the clip 10 so as to be movable between a temporary locking position P1 and a final locking position P2 (see FIG. 9) along the assembly direction Z. The rib 30 is formed in, for example, a flat rectangular plate shape along the width direction Y, and protrudes from the vehicle side along the assembly direction Z. For example, the protector 20 is attached via the clip 10 to the rib 30 provided at any position in the vehicle. The clip 10 functions as, for example, a fixing member for fixing the protector 20 to the rib 30.

The protector 20 includes, for example, a protector body 21 and a protector cover 22. The protector body 21 and the protector cover 22 are assembled to each other along the assembly direction Z to form an insertion space portion (routing space portion) through which the wiring member W is inserted. The protector body 21 and the protector cover 22 are formed, for example, separately from each other by synthetic resin or the like, and are integrated with each other by a lock structure (snap fit) using a lock portion (not illustrated). In FIG. 1, the wiring member W is inserted into the protector 20 along the axial direction X, but the present invention is not limited to this example. The wiring member W may be inserted into the protector 20, for example, along the width direction Y.

The wiring member W is configured by, for example, an electric wire bundle of a plurality of electric wires. The electric wires of the electric wire bundle extend linearly along the axial direction X and are formed to extend with substantially the same diameter with respect to the axial direction X (extending direction). In the electric wire, an outer side of a conductor portion (core wire) made of a plurality of conductive elemental wires is covered with an insulating sheath portion having an insulating property. In the electric wire, for example, a cross-sectional shape of the core wire (cross-sectional shape thereof intersecting the axial direction X) is formed in a substantially circular shape, a cross-sectional shape of the insulating sheath is formed in a substantially annular shape, and the electric wire is formed in a substantially circular cross-sectional shape as a whole. The electric wire bundle may include, for example, a plurality of first electric wires having a first outer diameter and a plurality of second electric wires having a second outer diameter smaller or larger than the first outer diameter.

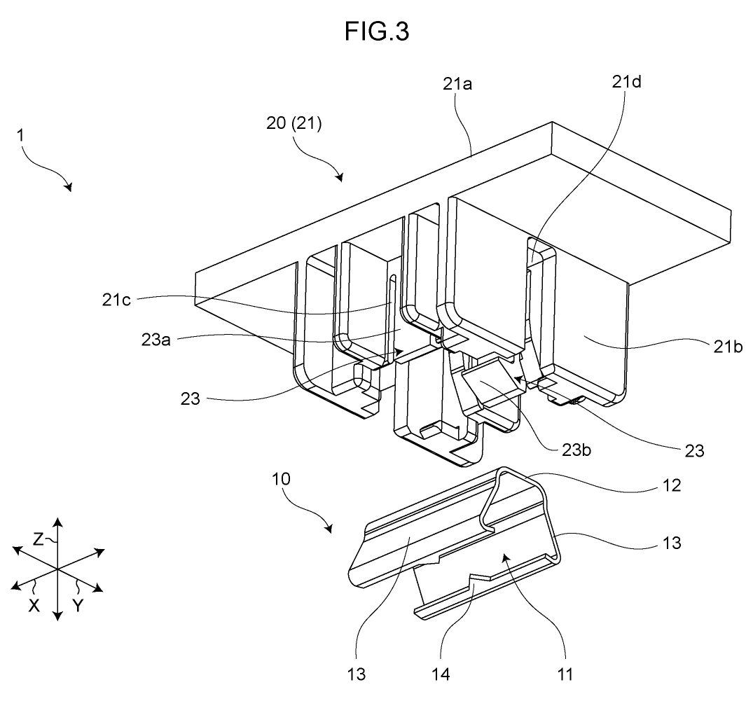

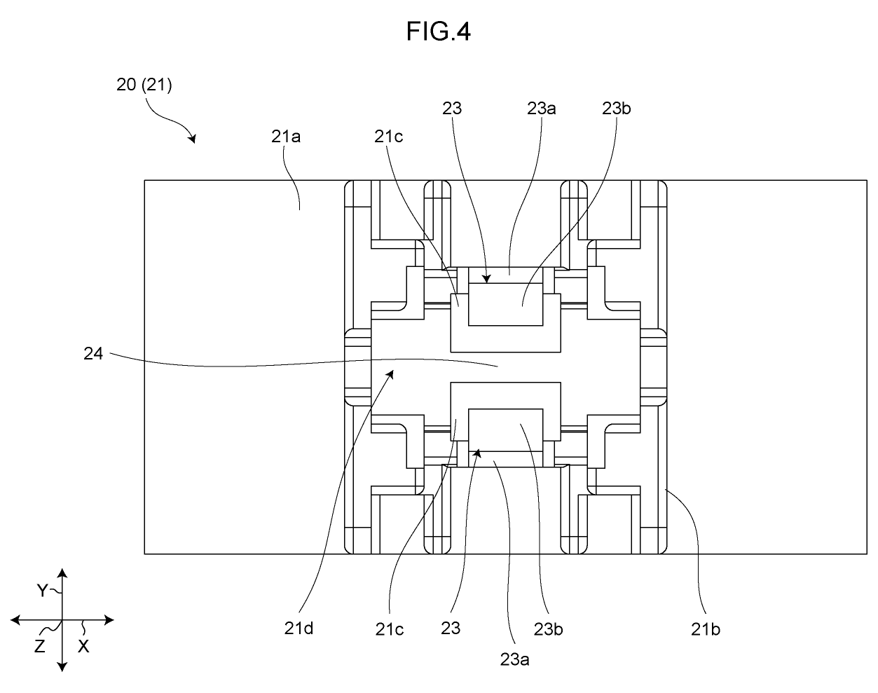

FIG. 3 is an exploded perspective view of the protector unit 1, and FIG. 4 is a plan view of the protector body 21 of the protector unit 1. As illustrated in FIGS. 3 and 4, the protector body 21 includes, for example, an upper wall portion 21a, a peripheral wall portion 21b, a cutout portion 21c, a recess 21d, a temporary locking portion 23, and a final locking portion 24. The upper wall portion 21a is a part forming one end (upper end) of the protector body 21 in the assembly direction Z. The upper wall portion 21a extends, for example, along a direction intersecting the assembly direction Z (XY plane) and is formed in a horizontally elongated rectangular flat plate shape along the axial direction X. The upper wall portion 21a functions as a structure forming an insertion space portion through which the wiring member W is inserted together with the protector cover 22 described above. The upper wall portion 21a is also referred to as a top wall portion, a bottom wall portion, or the like.

The peripheral wall portion 21b protrudes from the upper wall portion 21a toward the rib 30 along the assembly direction Z, that is, toward the other end (lower end) in the assembly direction Z. The peripheral wall portion 21b includes, for example, a pair of first peripheral wall portions located on both ends sides of the protector body 21 in the axial direction X and a pair of second peripheral wall portions located on both ends sides of the protector body 21 in the width direction Y. In the present embodiment, the recess 21d that is open toward the other end in the assembly direction Z is provided between the upper wall portion 21a and the pair of first peripheral wall portions as well as the pair of second peripheral wall portions of the peripheral wall portion 21b. The recess 21d is a space portion into which the clip 10 is inserted along the assembly direction Z and accommodated. In the present embodiment, the pair of first peripheral wall portions on both ends sides in the axial direction X of the peripheral wall portion 21b are provided with window portions (opening portions) for exposing the clip 10 inserted into the recess 21d to the outside.

The temporary locking portion 23 is provided, for example, on the pair of second peripheral wall portions on both ends sides in the width direction Y of the peripheral wall portion 21b. The temporary locking portion 23 serves to hold the clip 10 inserted into the recess 21d at the temporary locking position P1 (see FIG. 2). The temporary locking portion 23 includes, for example, a pair of arm portions 23a and a pair of claw portions 23b. The pair of arm portions 23a is formed in a cantilever spring shape on the pair of second peripheral wall portions. Specifically, the pair of arm portions 23a is configured such that one end side (upper end side) thereof in the assembly direction Z is connected to the pair of second peripheral wall portions, and the other end side (lower end side) thereof in the assembly direction Z is a free end elastically deformable along the width direction Y. The pair of claw portions 23b is formed in a claw shape at the other ends (lower ends, distal ends) of the pair of arm portions 23a in the assembly direction Z. The pair of claw portions 23b protrudes from the pair of arm portions 23a in directions approaching each other along the width direction Y.

The cutout portion 21c is, for example, a slit-shaped opening portion which allows the temporary locking portion 23 to elastically deform along the width direction Y. The cutout portion 21c is provided on the pair of second peripheral wall portions on both end sides in the width direction Y of the peripheral wall portion 21b corresponding to the temporary locking portion 23. Specifically, in the pair of second peripheral wall portions, the cutout portions 21c are provided to make a pair on both sides of the temporary locking portion 23 in the axial direction X. The pair of cutout portions 21c is a pair of slit-shaped openings penetrating the pair of second peripheral wall portions along the width direction Y, and extends in the assembly direction Z along the arm portions 23a and the claw portions 23b of the temporary locking portion 23.

The final locking portion 24 (see FIG. 4) is provided, for example, on the bottom of the recess 21d, that is, on the inner surface of the peripheral wall portion 21b in the upper wall portion 21a. The final locking portion 24 serves to hold the clip 10 inserted into the recess 21d at the final locking position P2 (see FIG. 9). The final locking portion 24 includes, for example, a restriction surface facing a bottom wall 12 of the clip 10 along the assembly direction Z. In the present embodiment, the restriction surface of the final locking portion 24 and the bottom wall 12 of the clip 10 come into contact with each other as the clip 10 is inserted into the recess 21d in the assembly direction Z, so that the clip 10 is held at the final locking position P2.

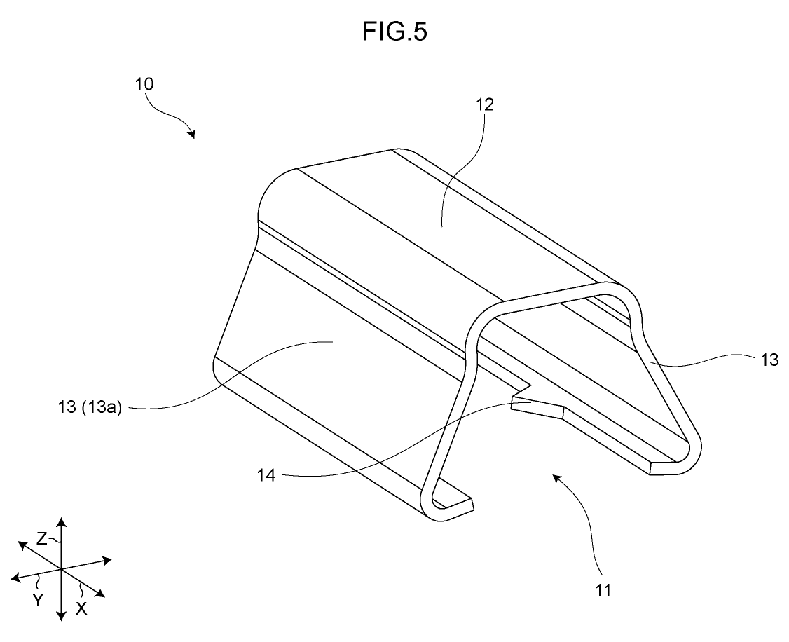

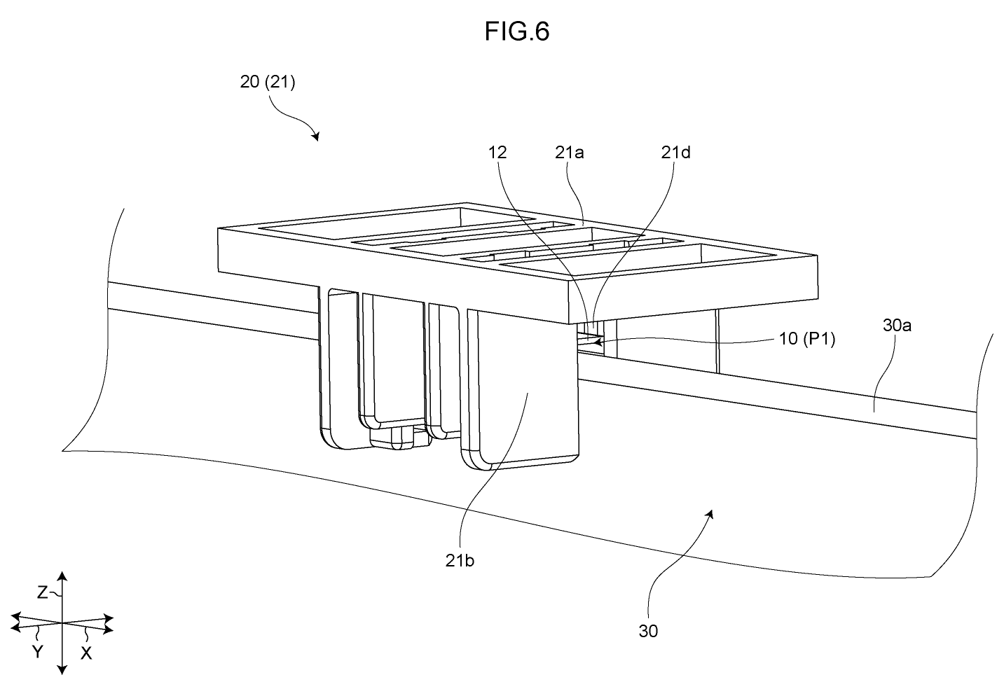

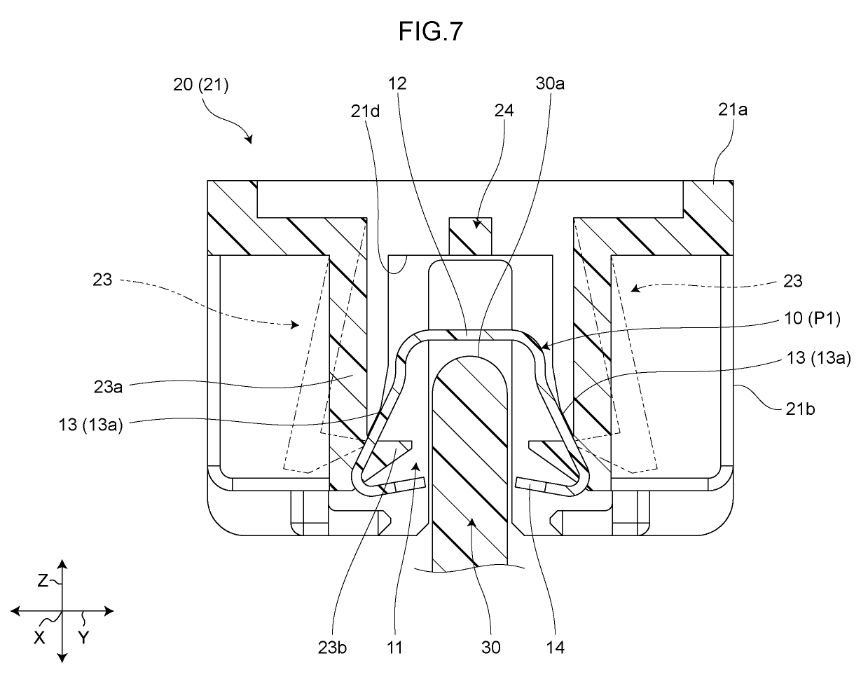

FIG. 5 is a perspective view of the clip 10 of the protector unit 1. As illustrated in FIG. 5, the clip 10 includes, for example, an insertion space portion 11, the bottom wall 12, a pair of side walls 13, and a pair of protrusions 14. The bottom wall 12 is a part forming one end (upper end) of the clip 10 in the assembly direction Z. The bottom wall 12 extends, for example, along a direction intersecting the assembly direction Z (XY plane) and is formed in a horizontally elongated rectangular flat plate shape along the axial direction X. The bottom wall 12 functions as a structure that defines the insertion space portion 11 of the clip 10 together with the pair of side walls 13 and the pair of protrusions 14. The insertion space portion 11 is a space portion into which the rib 30 (see FIGS. 6 and 7) is inserted along the assembly direction Z, is surrounded by the bottom wall 12, the pair of side walls 13, and the pair of protrusions 14, and is open toward the other end in the assembly direction Z. The bottom wall 12 faces an end surface 30a of the rib 30 in a state where the rib 30 is inserted into the insertion space portion 11.

For example, the pair of side walls 13 protrudes from both ends in the width direction Y of the bottom wall 12 toward the rib 30 along the assembly direction Z, that is, toward the other end (lower end) in the assembly direction Z. In the present embodiment, the pair of side walls 13 is formed in a tapered shape inclined toward directions away from each other along the width direction Y toward the rib 30 (the other end) in the assembly direction Z. That is, in the present embodiment, the opening area of the insertion space portion 11 expands in a tapered shape (trumpet-like shape) toward the rib 30 in the assembly direction Z. Each of the side walls 13 making a pair has an outer surface 13a facing the temporary locking portion 23. The pair of outer surfaces 13a is locked to the pair of claw portions 23b of the temporary locking portion 23 in a state where the clip 10 is located at the temporary locking position P1 (see FIG. 7), and is pressed from both sides in the width direction Y by the pair of arm portions 23a of the temporary locking portion 23 in a state where the clip 10 is located at the final locking position P2 (see FIG. 9). In addition, the pair of side walls 13 faces the side surfaces of the rib 30 in a state where the rib 30 is inserted into the insertion space portion 11.

For example, the pair of protrusions 14 protrudes in directions approaching each other along the width direction Y from ends of the pair of side walls 13 on the opposite side to the bottom wall 12 side, that is, the other ends (lower ends) in the assembly direction Z. The pair of protrusions 14 is a part locked to the rib 30 when the pair of side walls 13 goes over the temporary locking portion 23 along the assembly direction Z from a state where the clip 10 is located at the temporary locking position P1 (see FIG. 7). The pair of protrusions 14 includes, for example, a proximal end provided over the entire width of the pair of side walls 13 in the axial direction X, and a distal end partially provided at the central portion of the proximal end in the axial direction X. The pair of protrusions 14 protrudes in directions in which the distal ends thereof approach each other along the width direction Y more than the proximal end. The pair of distal ends is formed in, for example, a triangular shape having a vertex on a side approaching each other along the width direction Y. The pair of protrusions 14 faces the side surfaces of the rib 30 in a state where the rib 30 is inserted into the insertion space portion 11. For example, in a state where the clip 10 is located at the temporary locking position P1 (see FIG. 7), the pair of protrusions 14 is provided in a state where the distal ends are spaced apart from the side surfaces of the rib 30 along the width direction Y. On the other hand, for example, in a state where the clip 10 is located at the final locking position P2 (see FIG. 9), the pair of protrusions 14 is provided in a state where the distal ends abut on (wedge into) the side surfaces of the rib 30 along the width direction Y.

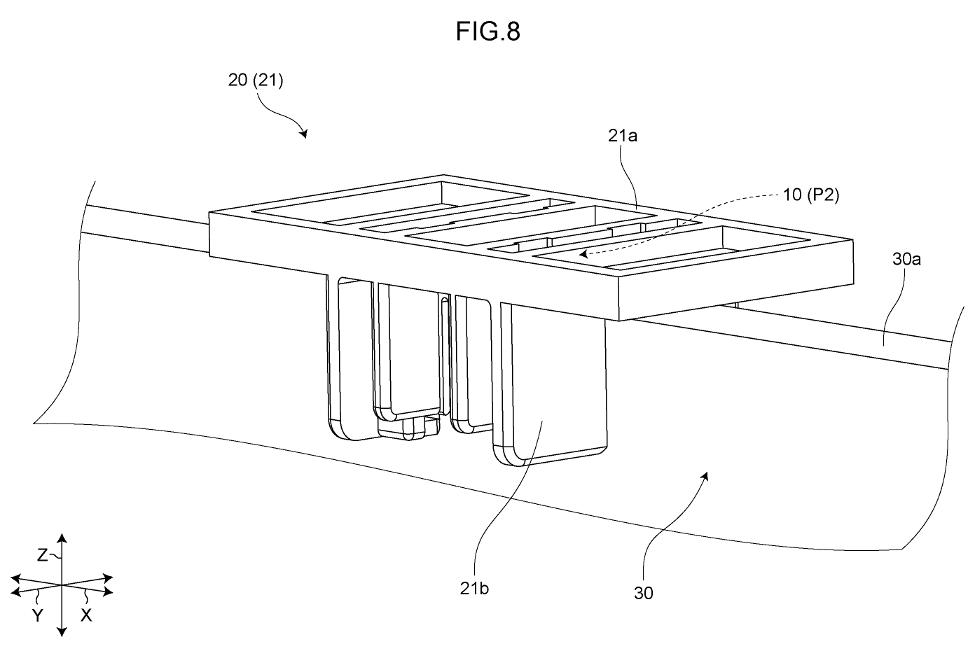

FIG. 6 is a perspective view of the protector unit 1 at the temporary locking position P1, FIG. 7 is a cross-sectional view of the protector unit 1 at the temporary locking position P1, FIG. 8 is a perspective view of the protector unit 1 at the final locking position P2, and FIG. 9 is a cross-sectional view of the protector unit 1 at the final locking position P2. As illustrated in FIGS. 6 to 9, in the present embodiment, the clip 10 is supported movably along the assembly direction Z between the temporary locking position P1 and the final locking position P2 by the temporary locking portion 23 and final locking portion 24 described above of the protector body 21.

As illustrated in FIGS. 6 and 7, in a state where the clip 10 is located at the temporary locking position P1, the bottom wall 12 is spaced apart from the final locking portion 24 along the assembly direction Z, and the pair of arm portions 23a of the temporary locking portion 23 elastically deforms in directions away from each other along the width direction Y than in the case of a free state. In FIG. 7, for convenience, the free state of the temporary locking portion 23 is indicated by a solid line, and the elastically deformed state thereof is indicated by a two-dot dash line. In the present embodiment, in the clip 10, the outer surfaces 13a of the pair of side walls 13 are locked to the pair of claw portions 23b of the temporary locking portion 23 in a state where the pair of arm portions 23a of the temporary locking portion 23 elastically deforms in directions away from each other along the width direction Y than in the case of the free state. As a result, elastic restoring force of the pair of arm portions 23a and the pair of claw portions 23b of the temporary locking portion 23 acts on the outer surfaces 13a of the pair of side walls 13, and the clip 10 is thus held at the temporary locking position P1.

In the present embodiment, the clip 10 moves from the temporary locking position P1 toward the final locking position P2 by going over the temporary locking portion 23 along the assembly direction Z as the rib 30 is inserted into the insertion space portion 11 in a state of being held by the temporary locking portion 23. Specifically, the clip 10 relatively moves along the assembly direction Z such that the bottom wall 12 is pushed, toward the final locking portion 24, into the final locking portion 24 as the rib 30 is inserted, whereby the pair of side walls 13 goes over the pair of claw portions 23b of the temporary locking portion 23 along the assembly direction Z. At this time, in the present embodiment, in a state where the clip 10 is located at the temporary locking position P1, the distal ends of the pair of protrusions 14 are spaced apart from the side surfaces of the rib 30 along the width direction Y, so that the insertability of the rib 30 into the insertion space portion 11 can be enhanced.

Then, as illustrated in FIGS. 8 and 9, in a state where the clip 10 is positioned at the final locking position P2, the bottom wall 12 abuts on the final locking portion 24 along the assembly direction Z to thereby hold the clip 10 at the final locking position P2. In a state where the clip 10 is located at the final locking position P2, the pair of arm portions 23a of the temporary locking portion 23 returns to the free state, and the pair of arm portions 23a presses the outer surfaces 13a of the pair of side walls 13 so that the pair of protrusions 14 elastically deforms in directions approaching each other along the width direction Y. In FIG. 9, for convenience, the free state of the clip 10 is indicated by a solid line, and the elastically deformed state thereof is indicated by a two-dot dash line. In the present embodiment, in a state where the clip 10 is located at the final locking position P2, the pair of side walls 13 elastically deforms such that the distal ends of the pair of protrusions 14 wedge into the rib 30 along the width direction Y. That is, in a state where the clip 10 is located at the final locking position P2, the pair of arm portions 23a presses the outer surfaces 13a of the pair of side walls 13 from both sides in the width direction Y such that the distance between the distal ends of the pair of protrusions 14 along the width direction Y is smaller than the thickness of the rib 30 along the width direction Y. Thus, the holding force with which the clip 10 holds the rib 30 can be increased.

As described above, in the protector unit 1 and the wire harness WH of the present embodiment, the clip 10 moves from the temporary locking position P1 toward the final locking position P2 by going over the temporary locking portion 23 along the assembly direction Z as the rib 30 is inserted into the insertion space portion 11 in a state of being held by the temporary locking portion 23, and is locked to the rib 30 by being pressed, by the temporary locking portion 23 having returned to a free state, from both sides in the width direction Y. With this configuration, for example, the protector unit 1 and the wire harness WH can increase the holding force with which the clip 10 holds the rib 30 at the final locking position P2 while the clip 10 can be fitted to the protector body 21 from the temporary locking position P1 toward the final locking position P2 with a low insertion force as the rib 30 is inserted. As a result, the protector unit 1 and the wire harness WH can improve the assemblability, and further, the fitting feeling accompanying the operation of fitting the clip 10 from the temporary locking position P1 toward the final locking position P2 can be easily informed to an assembling operator.

In the protector unit 1 and the wire harness WH of the present embodiment, the clip 10 includes the bottom wall 12 facing the end surface 30a of the rib 30, the pair of tapered side walls 13 that protrudes from both ends of the bottom wall 12 in the width direction Y toward the rib 30 along the assembly direction Z and is inclined so as to be spaced apart from each other along the width direction Y toward the rib 30 in the assembly direction Z, and the pair of protrusions 14 that protrudes from ends of the pair of side walls 13 on a side opposite to the bottom wall 12 side in directions approaching each other along the width direction Y and is locked to the rib 30 when the pair of side walls 13 goes over the temporary locking portion 23 along the assembly direction Z, and the insertion space portion 11 is a space portion surrounded by the bottom wall 12, the pair of side walls 13, and the pair of protrusions 14. With this configuration, for example, the protector unit 1 and the wire harness WH can relatively easily achieve the clip 10 that can be fitted from the temporary locking position P1 toward the final locking position P2 with a low insertion force as the rib 30 is inserted into the insertion space portion 11 and can increase the holding force with which the rib 30 is held at the final locking position P2.

In the protector unit 1 and the wire harness WH of the present embodiment, the temporary locking portion 23 includes the pair of arm portions 23a provided on both sides of the clip 10 in the width direction Y and elastically deformable along the width direction Y, and the pair of claw portions 23b protruding from the pair of arm portions 23a in directions approaching each other along the width direction Y, and the pair of claw portions 23b is locked to the outer surfaces 13a of the pair of side walls 13 in a state where the clip 10 is located at the temporary locking position P1, and the outer surfaces 13a of the pair of side walls 13 are pressed by the pair of arm portions 23a having returned to the free state so that the pair of protrusions 14 elastically deforms in directions approaching each other along the width direction Y in a state where the clip 10 is located at the final locking position P2. With this configuration, the protector unit 1 and the wire harness WH can relatively easily achieve the temporary locking portion 23 that holds the outer surfaces 13a of the pair of side walls 13 in a state where the clip 10 is located at the temporary locking position P1, for example, and is capable of elastically deforming the pair of protrusions 14 by pressing the outer surfaces 13a of the pair of side walls 13 in a state where the clip 10 is located at the final locking position P2.

In the protector unit 1 and the wire harness WH of the present embodiment, the protector body 21 includes the recess 21d into which the clip 10 is inserted along the assembly direction Z, and the final locking portion 24 is provided at the bottom of the recess 21d and holds the clip 10 at the final locking position P2 by abutting on the bottom wall 12. With this configuration, the protector unit 1 and the wire harness WH can hold the clip 10 at the final locking position P2 more easily, more smoothly, or more reliably using the final locking portion 24 provided at the bottom of the recess 21d, for example.

In the present embodiment, the case where the temporary locking portion 23 includes the pair of arm portions 23a provided on the pair of second peripheral wall portions on both ends sides in the width direction Y of the peripheral wall portion 21b has been exemplified, but the present invention is not limited to this example. For example, the temporary locking portion 23 may include a plurality of pairs of arm portions 23a provided on the pair of second peripheral wall portions at intervals along the axial direction X.

Although the embodiment of the present invention has been exemplified above, the embodiment is merely an example, and is not intended to limit the scope of the invention. The above-described embodiment can be implemented in various other forms, and various omissions, substitutions, combinations, and changes can be made without departing from the gist of the invention. In addition, specifications (Structure, type, direction, form, size, length, width, thickness, height, number, arrangement, position, material, and the like) of each configuration, shape, and the like can be appropriately changed and implemented.

The protector unit and the wire harness according to the present embodiment have an effect of improving the assemblability.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A protector unit comprising:
a clip including an insertion space portion into which a plate-shaped rib on a vehicle side is inserted along an assembly direction; and
a protector including a protector body that supports the clip so as to be movable between a temporary locking position and a final locking position along the assembly direction, a temporary locking portion that is provided in the protector body and holds the clip at the temporary locking position, and a final locking portion that is provided in the protector body and holds the clip at the final locking position, wherein
the clip moves from the temporary locking position toward the final locking position by going over the temporary locking portion along the assembly direction as the rib is inserted into the insertion space portion in a state of being held by the temporary locking portion, and is locked to the rib by being pressed, by the temporary locking portion having returned to a free state, from both sides in a width direction intersecting the assembly direction.

2. The protector unit according to claim 1, wherein
the clip includes a bottom wall facing an end surface of the rib, a pair of tapered side walls that protrudes from both ends of the bottom wall in the width direction toward the rib along the assembly direction and is inclined so as to be spaced apart from each other along the width direction toward the rib in the assembly direction, and a pair of protrusions that protrudes from ends of the pair of side walls on a side opposite to the bottom wall side in directions approaching each other along the width direction and is locked to the rib when the pair of side walls goes over the temporary locking portion along the assembly direction, and
the insertion space portion is a space portion surrounded by the bottom wall, the pair of side walls, and the pair of protrusions.

3. The protector unit according to claim 2, wherein
the temporary locking portion includes a pair of arm portions provided on both sides of the clip in the width direction and elastically deformable along the width direction, and a pair of claw portions protruding from the pair of arm portions in directions approaching each other along the width direction, and
the pair of claw portions is locked to outer surfaces of the pair of side walls in a state where the clip is located at the temporary locking position, and the outer surfaces of the pair of side walls are pressed by the pair of arm portions having returned to the free state so that the pair of protrusions elastically deforms in directions approaching each other along the width direction in a state where the clip is located at the final locking position.

4. The protector unit according to claim 2, wherein
the protector body includes a recess into which the clip is inserted along the assembly direction, and
the final locking portion is provided at a bottom of the recess and holds the clip at the final locking position by abutting on the bottom wall.

5. The protector unit according to claim 3, wherein
the protector body includes a recess into which the clip is inserted along the assembly direction, and
the final locking portion is provided at a bottom of the recess and holds the clip at the final locking position by abutting on the bottom wall.

6. A wire harness comprising:
a wiring member having conductivity; and
a protector unit externally mounted on the wiring member, wherein
the protector unit includes
a clip including an insertion space portion into which a plate-shaped rib on a vehicle side is inserted along an assembly direction; and
a protector including a protector body that supports the clip so as to be movable between a temporary locking position and a final locking position along the assembly direction, a temporary locking portion that is provided in the protector body and holds the clip at the temporary locking position, and a final locking portion that is provided in the protector body and holds the clip at the final locking position, wherein
the clip moves from the temporary locking position toward the final locking position by going over the temporary locking portion along the assembly direction as the rib is inserted into the insertion space portion in a state of being held by the temporary locking portion, and is locked to the rib by being pressed, by the temporary locking portion having returned to a free state, from both sides in a width direction intersecting the assembly direction.
